(19) United States
(12) Patent Application Publication
(10) Pub. No.: US 2010/0328094 A1
(43) Pub. Date: Dec. 30, 2010

(54) ROTATABLE REMOTE CONTROL

(75) Inventor: WEN-YAN YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/566,685

(22) Filed: Sep. 25, 2009

(30) Foreign Application Priority Data
Jun. 30, 2009 (CN) 200910303883.2

(51) Int. Cl. G08C 19/00

(52) U.S. Cl. 340/825.69

(57) ABSTRACT

A rotatable remote control is provided. The remote control includes a main body, a circuit board attached to the main body, and a rotatable body received in the main body. A plurality of first elastic conductive elements is mounted on the circuit board. The rotatable body includes a pressing projection. The remote control further includes a chip mounted on the circuit board. The chip includes a plurality of input pins and each of the input pins corresponds to a first conductive element. When one of the first conductive element is pressed by the pressing projection, the input of the input pin corresponding to the first conductive element is changed. The chip determines whether to generate a remote control signal to control an electronic device to execute a preset function according to the detected change of the input pins.

### BACKGROUND

1. Technical Field

The present disclosure relates to remote controls and, particularly, to a rotatable remote control.

2. Description of Related Art

Nowadays people usually use remote controls having quite a few keys to operate electronic devices, for example TVs. Frequently using such remote controls may cause users to be in a monotony and aridity mood.

### BRIEF DESCRIPTION OF THE DRAWINGS

The components of the drawings are not necessarily drawn to scale, the emphasis instead being placed upon clearly illustrating the principles of the rotatable remote control. Moreover, in the drawings, like reference numerals designate corresponding parts throughout several views.

FIG. 1 is an isometric view of the rotatable remote control in accordance with an exemplary embodiment.

FIG. 2 is an exploded, perspective view of the rotatable remote control of FIG. 1.

FIG. 3 is another exploded, perspective view of the rotatable remote control of FIG. 1, viewed from a different perspective.

FIG. 4 is a cross-sectional, perspective view of the rotatable remote control of FIG. 1, taken along the line IV-IV.

FIG. 5 is a block diagram of the rotatable remote control of FIG. 1.

FIG. 6 is a circuit diagram of the rotatable remote control of FIG. 5.

### DETAILED DESCRIPTION

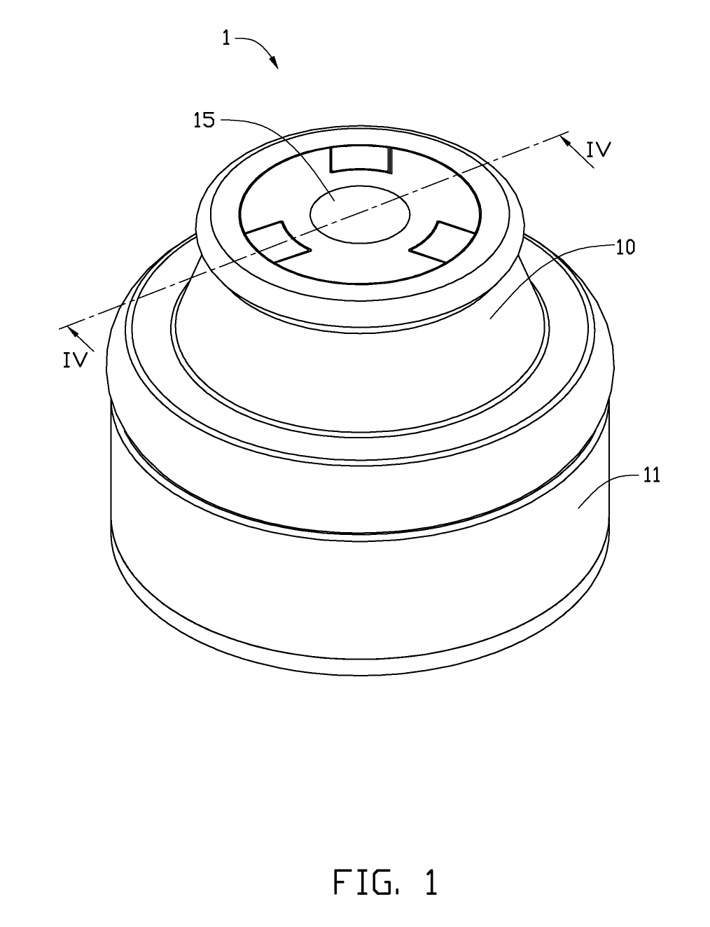

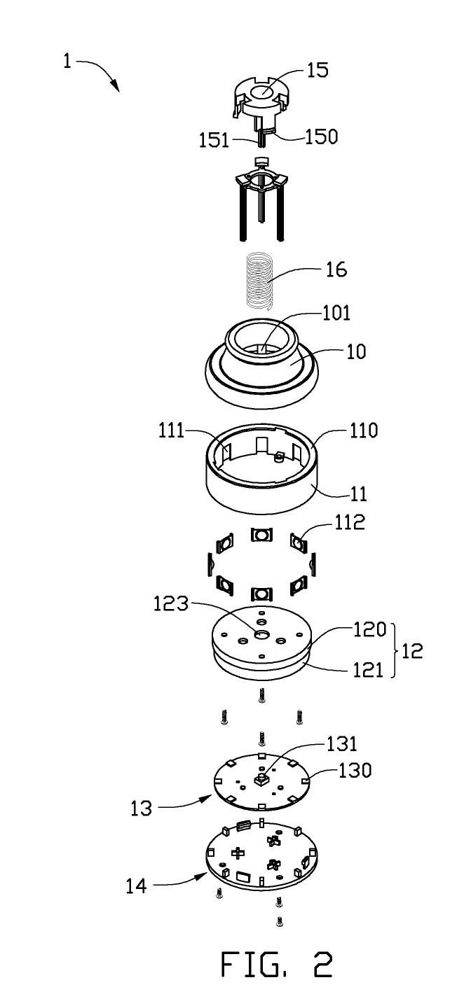

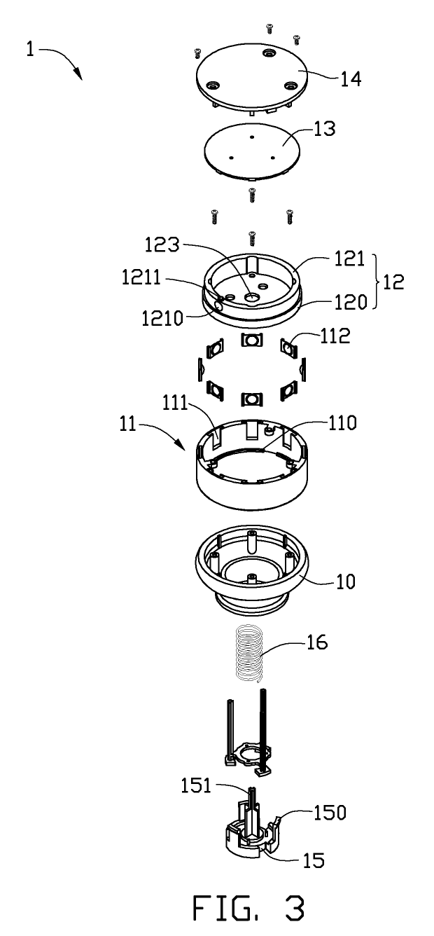

Referring FIGS. 1-3, an embodiment of a rotatable remote control 1 is illustrated. The remote control 1 includes a first cover 10, a main body 11, a rotatable body 12, a circuit board 13, and a second cover 14. The rotatable body 12 is received in the main body 11, and attached to the first cover 10. Therefore, when the first cover 10 is rotated, the rotatable body 12 is correspondingly rotated. The circuit board 13 is attached to the second cover 14, and the second cover 14 is attached to the main body 11.

In the embodiment, the main body 11 is generally cylindrical and includes a through hole (not labeled) along the axis of the main body 11. A stopper portion 110 protrudes out from the top end of the main body 11 and extends towards the axis of the main body 11. The second cover 14 and the stopper portion 110 are cooperatively for preventing the rotatable body 11 from sliding out from the main body 11. A plurality of receiving grooves 111 is defined in the inner sidewall of the main body 11. Each receiving groove 111 receives an elastic member 112. Each of the elastic members 112 includes an elastic projection (not labeled).

In the embodiment, the rotatable body 12 includes a first cylinder 120 and a second cylinder 121 attached to the first cylinder 120. The first cylinder 120 is hollow and includes a top surface (not labeled). The second cylinder 121 includes a through hole (not labeled) along the axis of the second cylinder 121. The radius of the first cylinder 120 is generally equal to that of the main body 11, and the radius of the second cylinder 121 is less than that of the main body 11. A positioning projection 1210 protrudes out from the outer sidewall of the second cylinder 121, and a pressing projection 1211 protrudes out from the bottom end of the second cylinder 121. The pressing projection 1211 is adjacent to the positioning projection 1210.

A plurality of first elastic conductive element 130 is mounted on the circuit board 13. In the embodiment, the number of the conductive element 130 is equal to that of the receiving grooves 111, and each conductive element 130 is aligned with a receiving groove 111.

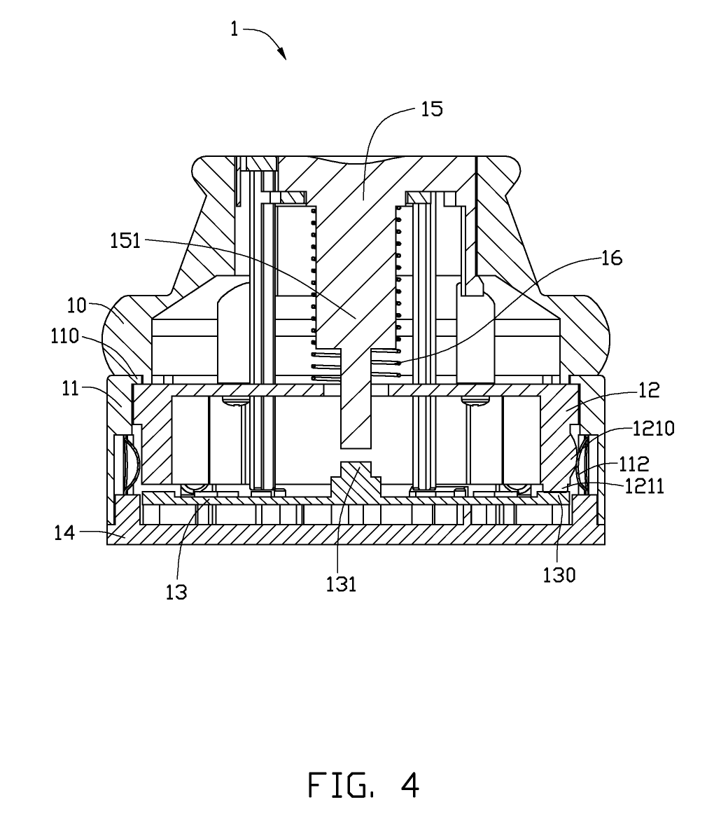

Referring also to FIG. 4, when the rotatable body 12 is rotated, causing the positioning projection 1210 to contact with the elastic projection of the elastic member 113, the pressing projection 1211 presses the conductive element 130 aligned with the elastic member 112. In the embodiment, when the pressing projection 1211 presses one of the conductive elements 130, the remote control 1 generates a remote signal to control an electronic device to execute a preset function.

In an alternative embodiment, the remote control 1 further includes a confirm button 15. When one of the conductive elements 130 is pressed by the pressing projection 1211 and the confirm button 15 is activated, the remote control 1 generates a remote signal to control an electronic device to execute a preset function.

The confirm button 15 includes at least one hook 150 and a pressing post 151. A spring 16 is placed over the pressing post 151. At least one latching slot 101 is defined in the inner surface of the first cover 10. Each hook 150 is received in one slot 101 and can slide along the slot 101. The confirm button 15 is movably connected to the first cover 10 via the hook 150 and the spring 16. When the confirm button 15 is pressed, the hook 150 moves downwards along the latching slot 101, and the spring 16 is compressed. When the confirm button 15 is released, the spring 16 extends to cause the confirm button 15 to resume its original position. A through hole 123 is defined in the top surface of the rotatable body 12, and a second elastic conductive element 131 is mounted on the circuit board 13. The pressing post 151 of the confirm button 15 extends through the through hole 123. When the confirm button 15 is pressed, the end of the pressing post 151 presses the conductive element 131.

In another alternative embodiment, when the duration of the press on one of the conductive elements 130 reaches a preset time interval, the remote control 1 generates a remote signal to control an electronic device to execute a preset function.

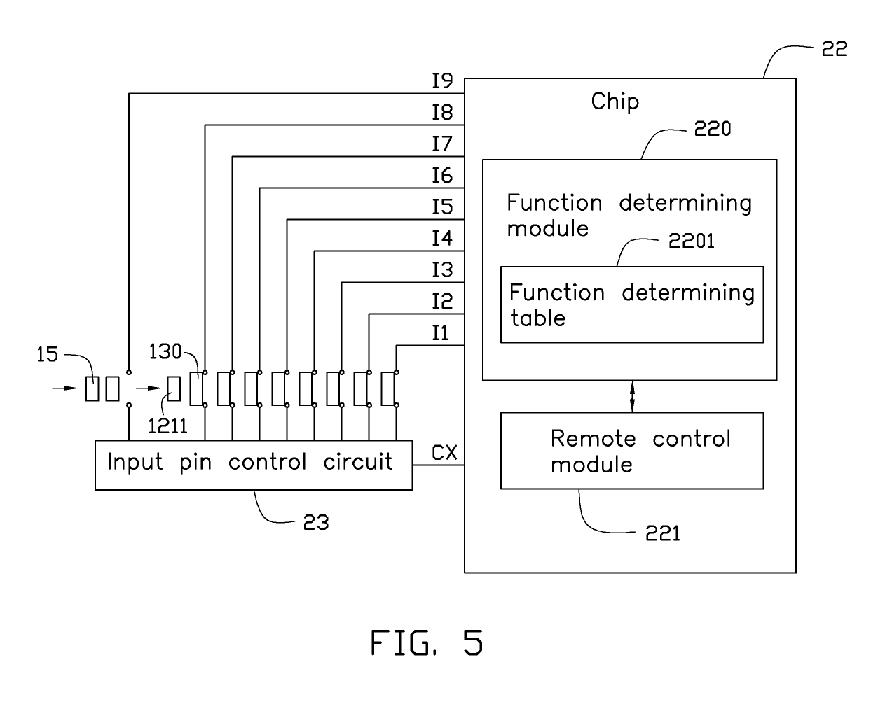

Referring also to FIG. 5, the remote control 1 includes a chip 22 and an input pin control circuit 23. The chip 22 includes a plurality of input pins and a control pin labeled CX. In the embodiment, the number of the input pins is nine and labeled I1-I9.

In the embodiment, each of the input pins I1-I8 corresponds to a conductive element 130. When a conductive element 130 is not pressed by the pressing projection 1211, the input of the input pin corresponding to the conductive element 130 is high voltage. When a conductive element 130 is pressed by the pressing projection 1211, the input pin corresponding to the conductive 130 is electrically connected to the control circuit 23 via the conductive element 130, and the input of the input pin is changed to low voltage.

The input pin I9 corresponds to the conductive element 131. When the conductive element 131 is not pressed by the end of the pressing post 151 of the confirm button 15, the input of the input pin I9 is high voltage. When the confirm button 15 is pressed, causing the pressing post 151 to press the conductive element 131, the input pin I9 is electrically connected to the control circuit 23 via the conductive element 131, and the input of the input pin I9 is changed to low voltage.

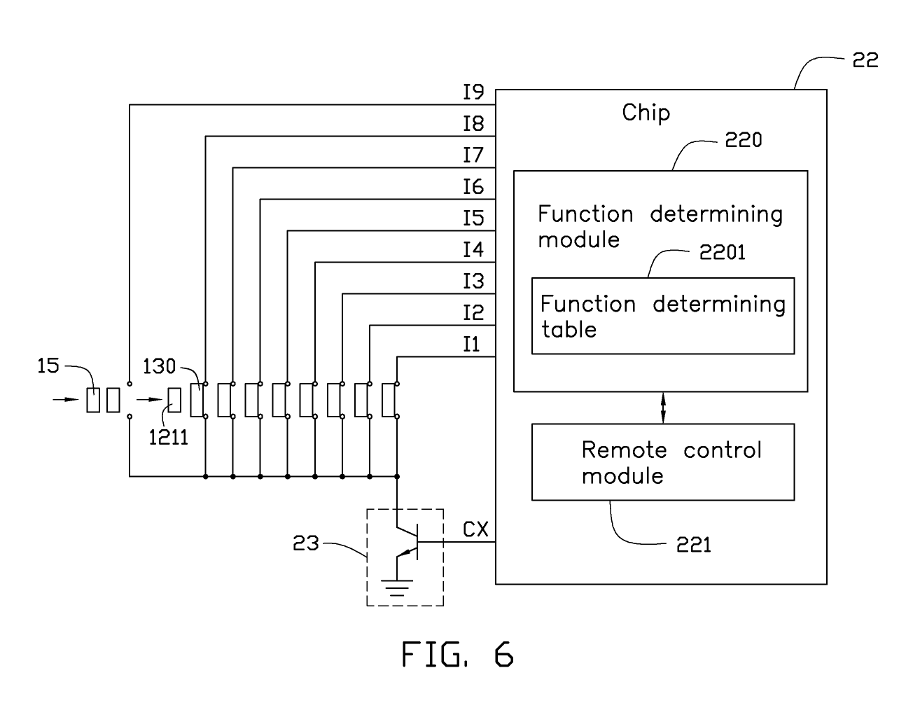

The control pin CX is electrically connected to the control circuit 23. In the embodiment, when the input of the control pin CX is high voltage, the rotatable remote control 1 is unlocked, otherwise the remote control 1 is locked. That is, when the input of the control pin CX is high voltage and one of the first conductive elements 130 is pressed, the input pin corresponding to the first conductive element 130 is changed to low voltage. Referring also to FIG. 6, in the embodiment, the control circuit 23 is a transistor 23. The base of the transistor 23 is electrically connected to the control pin CX, and the emitter is electrically connected to the ground. When one of the conductive elements 130 is pressed by the pressing projection 1211, the input pin corresponding to the conductive element 130 is electrically connected to the collector of the transistor 23.

The chip 22 further includes a function determining module 220 and a remote control module 221.

The function determining module 220 includes a function determining table 2201 (shown below). In the table 2201, each of the input pins I1-I8 corresponds to a preset function. The function determining module 220 detects the input of the input pins I1-I8 and determines which function will be executed according to the detected input of the input pins I1-I8 and the function determining table 2201. In the embodiment, when the function determining module 220 determines the input of one of the input pins I1-I8 is low voltage, the remote control module 221 generates a control signal to control an electronic device to execute a preset function.

Function Determining Table

| Input Pin | Preset Function |
|---|---|
| I1 = 0 | A |
| I2 = 0 | B |
| I3 = 0 | C |
| I4 = 0 | D |
| . . . | . . . |

In an alternative embodiment, the function determining module 220 determines the input of one of the input pins I1-I8 and the input pin I9 are low voltage, the remote control module 221 generates a control signal to control an electronic device to execute a preset function.

In another alternative embodiment, when the function determining module 220 determines the input of one of the input pins I1-I8 is low voltage within a predetermined time interval, the remote control module 221 generates a control signal to control an electronic device to execute a preset function.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A rotatable remote control comprising:
a main body;
a circuit board attached to the main body, wherein a plurality of first elastic conductive elements are mounted on the circuit board;
a rotatable body comprising a pressing projection, wherein the rotatable body is received in the main body, when the rotatable body is rotated, the pressing projection presses one of the first conductive elements; and
a chip mounted on the circuit board, wherein the chip comprises a plurality of input pins and each of the input pins corresponds to one of the first conductive elements; when one of the first conductive elements is pressed by the pressing projection, the input of the input pin corresponding to the first conductive element is changed, and the chip detects the change of the input pins, and determines whether to generate a remote control signal to control an electronic device to execute a preset function according to the detected change of the input pins.

2. The rotatable remote control as described in claim 1, further comprising a confirm button and a second elastic conductive element mounted on the circuit board, wherein the second conductive element corresponds to the confirm button and can be operated by the confirm button; and
the chip further comprises an input pin corresponding to the second conductive element, when the confirm button is pressed, the input of the input pin corresponding to the second conductive element is changed; the chip determines whether to generate a control signal to control the electronic device to execute a preset function according to the change of the input of the input pins corresponding to the first conductive elements and the input pin corresponding to the second conductive element.

3. The rotatable remote control as described in claim 1, wherein when the chip detects one of the first conductive elements is pressed for a preset time interval, the chip generates a control signal to control the electronic device to execute a preset function.

4. The rotatable remote control as described in claim 1, wherein the chip comprises a function determining module and a remote control module, wherein the function determining module comprises a function determining table defining relationships between the input pins and preset functions, and the function determining module determines which function will be executed according to the change of the input of the input pins and the function determining table; and the remote control module is configured for generating a remote control signal when the function determining module determines a preset function will be executed.

5. The rotatable remote control as described in claim 1, wherein the chip further comprises a control pin, the control pin is configured for starting and locking the rotatable remote control.

6. The rotatable remote control as described in claim 5, further comprising a transistor mounted on the circuit board, the base of the transistor is electrically connected to the control pin, the emitter of the transistor is electrically connected to the ground, and when one of the first conductive elements is pressed by the pressing projection, the input pin corresponding to the first conductive element is electrically to the collector of the transistor.

7. The rotatable remote control as described in claim 1, further comprising a plurality of elastic elements, wherein the main body is hollow and a plurality of receiving grooves is defined in the inner sidewall of the main body, each of the receiving grooves receives an elastic element; and a positioning projection protrudes out from the outer sidewall of the rotatable body, when the rotatable body is rotated, it cause the positioning projection to contact with one of the elastic elements, and the pressing projection to press one of the first conductive elements.

8. The rotatable remote control as described in claim 1, further comprising a cover, wherein the rotatable body is attached to the cover, when the cover is rotated, the rotatable body is correspondingly rotated.

9. The rotatable remote control as described in claim 8, wherein a stopper portion protrudes out from the top end of the main body, the stopper portion is for preventing the rotatable body from sliding out from the main body.

10. The rotatable remote control as described in claim 2, further comprising a cover and a spring, wherein the rotatable body is attached to the cover; at least one latching slot is defined in the inner sidewall of the cover; the confirm button comprises at least one hook and a pressing post, the hook is received in the latching slot and can slide in the latching slot, the spring is placed over the pressing post, the confirm button is movably connected to the cover via the hook and the spring; when the confirm button is pressed, the hook moves downwards along the latching slot, the spring is compressed, and the pressing post presses the second conductive element.

11. The rotatable remote control as described in claim 10, wherein a stopper portion protrudes out from the top end of the main body, the stopper portion is for preventing the rotatable body from sliding out from the main body.
